(19) United States
(12) Patent Application Publication
(10) Pub. No.: US 2025/0030360 A1
(43) Pub. Date: Jan. 23, 2025

(54) POWER CONDITIONING DEVICE FOR POWER GENERATORS

(71) Applicant: Imperial Industrial Supply Co., Ontario, CA (US)

(72) Inventor: Robert Johnson, Ontario, CA (US)

(73) Assignee: Imperial Industrial Supply Co., Ontario, CA (US)

(21) Appl. No.: 18/777,708

(22) Filed: Jul. 19, 2024

Related U.S. Application Data
(60) Provisional application No. 63/527,803, filed on Jul. 19, 2023.

(51) Int. Cl. H02P 9/10; H02P 9/30

(52) U.S. Cl. CPC H02P 9/107; H02P 9/305

(57) ABSTRACT

A power generator includes an engine configured to provide mechanical energy. A shaft is mechanically coupled to the engine to transmit the mechanical energy. An alternator is mechanically coupled to the shaft and configured to cover the mechanical energy into electrical energy. A control panel is configured to manage the operation of the engine and the alternator. A power conditioning device is disposed between one or more circuit breakers and an outlet of the control panel.

### BACKGROUND

The present application generally relates to power generation systems and more specifically to a power conditioning device for power generators.

Power generators (referred to herein as “generators” for brevity) are used as reliable sources of power in various industries and residential applications and are integral to systems or devices that require an uninterrupted power supply. There are many types of generators, such as portable generators and standby or backup generators. Portable generators are designed to provide temporary electrical power and are typically compact and lightweight enough to be moved from place to place. As such, portable generators are ideal for providing power in remote locations or during temporary situations like camping trips or construction projects. A portable generator typically runs on fuel, which is stored in a tank on the generator. The fuel is fed into an internal combustion engine, and as the engine runs, it turns a shaft mechanically coupled to an alternator. The alternator is responsible for converting mechanical energy into electrical energy and uses the principle of electromagnetic induction to produce an electric current. A voltage regulator ensures a consistent voltage output from the alternator, protecting connected devices from voltage spikes or drops. The electric current generated is then directed to the outlets on the generator, ready for use by various electrical devices.

Backup generators, also known as standby generators, are installed permanently at a home or business and provide uninterrupted backup power in case of a power outage. Similar to portable generators, backup generators typically run on fuel. However, rather than having a fuel tank at the generator, the fuel is usually drawn from a local utility line or a large tank located nearby. Much like portable generators, backup generators use an engine to turn an alternator and produce electricity. However, these components are usually larger and more powerful than those found in portable generators, allowing backup generators to power an entire home or business. Backup generators typically implement an automatic transfer switch (ATS) that constantly monitors the utility power for an interruption. If the utility power goes out, the ATS will signal the generator to start. Once the ATS signals that utility power has been lost, the backup generator starts up and reaches an operational speed. The ATS then switches the electrical load from the utility to the generator. When utility power is restored, the ATS senses this, switches the electrical load back to the utility, and signals the generator to shut down.

### BRIEF SUMMARY

In accordance with some embodiments, a power generator includes an engine configured to provide mechanical energy. A shaft is mechanically coupled to the engine to transmit the mechanical energy. An alternator is mechanically coupled to the shaft and configured to cover the mechanical energy into electrical energy. A control panel is configured to manage the operation of the engine and the alternator. A power conditioning device is disposed between one or more circuit breakers and an outlet of the control panel.

In various embodiments, the power conditioning device includes an inrush current management system configured according to one or more of the following aspects. In one aspect the inrush current management system is configured to gradually ramp up power supplied to a load when the load is first connected to the power generator. In another aspect, the inrush current management system includes a soft start controller configured to gradually increase voltage supplied to the load over a predefined period.

In various embodiments, the power conditioning device includes a power factor correction system configured according to one or more of the following aspects. In one aspect, power factor correction system is configured to monitor and adjust a power factor of an output of the power generator. In another aspect, the power factor correction system includes a monitoring unit configured to continuously measure the power factor of the generator output and also includes a reactive power management unit configured to add or subtract reactive power to the generator output based on the measured power factor.

In various embodiments, the power further includes a surge protection system configured to protect the power generator and a load connected to the power generator from voltage surges.

In various embodiments, the power conditioning device is removably inserted into the control panel.

In various embodiments, the power conditioning device is hardwired into the control panel.

In various embodiments, the power generator is a portable power generator.

In various embodiments, the power generator is a standby power generator.

In various embodiments, the outlet is coupled to an air conditioning unit.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present disclosure, in which:

FIG. 1 is a block diagram of a generator implementing a power condition device in accordance with some embodiments.

FIG. 2 is an example wiring diagram of the generator of FIG. 1 in accordance with some embodiments.

### DETAILED DESCRIPTION

Generators are integral to numerous industries and settings that require reliable and stable power. Although generators are employed as portable, primary, or backup power sources, generators often struggle with the issue of power factor inefficiency, particularly when powering inductive loads. The power factor is the ratio of real power, which performs useful work, to apparent power, which is the product of current and voltage supplied to a load. An ideal power factor of 1 indicates that all the supplied power is effectively converted into useful work. However, in real-world scenarios, especially with inductive loads, the power factor is often less than 1 due to the phase shift between current and voltage. As such, power factor inefficiency leads to increased current flow, reduced system efficiency, and potential voltage and frequency drops, thereby resulting in operational inefficiencies, increased costs, and potential overheating and damage to the generator or connected electrical devices. This inefficiency leads to increased current flow, reduced system efficiency, and potential voltage and frequency drops, thereby resulting in operational inefficiencies, increased costs, and potential overheating and damage to the generator or connected electrical devices.

Power factor issues can occur for various reasons. For example, when many types of devices, such as air conditioning units or motors, are first started, they draw a large inrush current that can be several times their normal operating current. This is because when the device is first energized, it appears almost like a short circuit to the generator. This sudden draw of current can cause a voltage drop and introduce a significant phase shift between the current and voltage waveforms, which in turn leads to a lower power factor. Also, many devices, particularly those with inductive loads, create reactive power. Reactive power is the portion of electricity that establishes and sustains the electric and magnetic fields of inductive loads. Reactive power causes the current waveform to lag behind the voltage waveform, reducing the power factor. At startup, the demand for reactive power can be particularly high as the device's magnetic fields are first established, causing the power factor to dip.

In many instances, power factor issues result in voltage and frequency drops. For example, the inrush current drawn during the startup of a device can cause a significant, albeit temporary, voltage drop. This is because the sudden large demand for current can exceed the generator's ability to maintain a stable voltage output. Furthermore, when the power factor of a system is low, the generator must supply more current for the same amount of useful power (real power). High current can lead to increased voltage drops across the generator's internal windings and any wiring between the generator and the load, leading to a reduced voltage at the load. Moreover, generators work by converting mechanical energy into electrical energy. When a large load is suddenly applied, such as during the startup of an air conditioning unit or motor, the generator has to work harder to maintain the same speed. If the generator's control system is not able to respond quickly enough, or if the load is too large, this can lead to a temporary reduction in the generator's speed, which directly reduces the frequency of the generated electrical power.

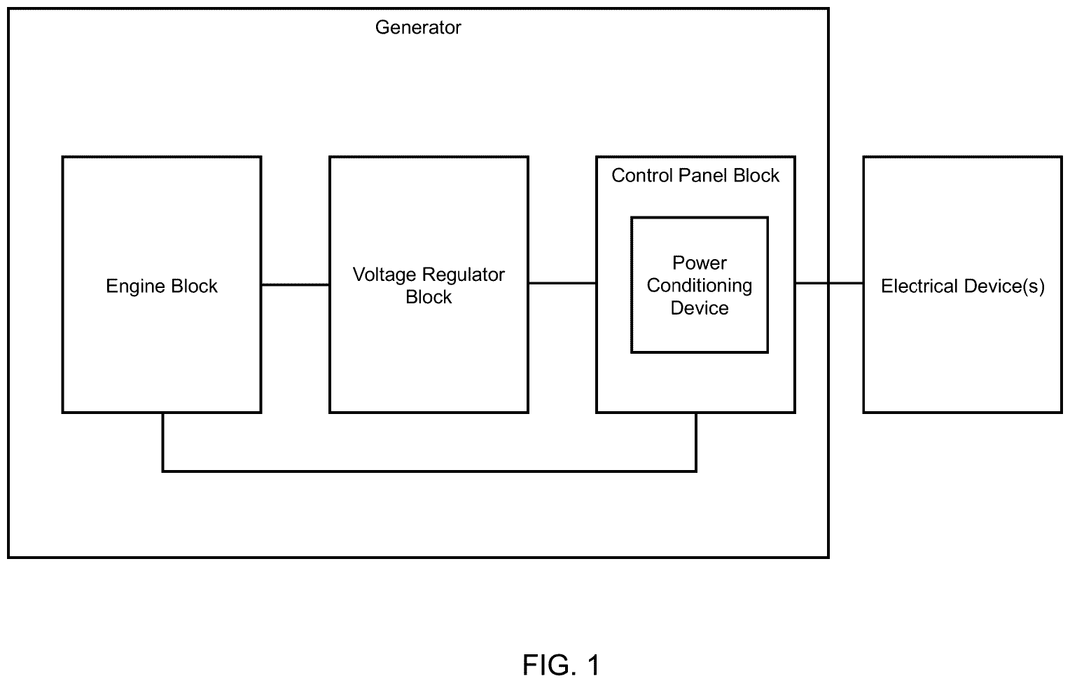

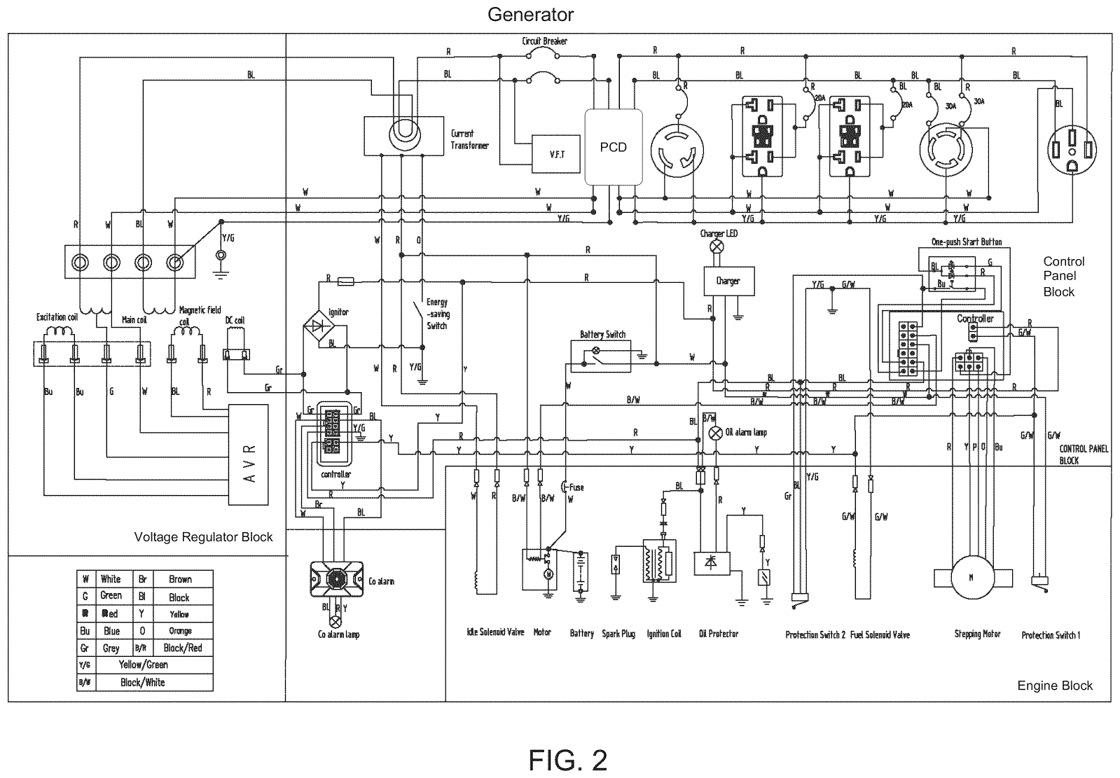

As such, the following describes embodiments of components and systems for implementing inductive power factor correction at a generator. For example, FIG. 1 illustrates a block diagram of a generator (e.g., a portable generator, a backup generator, etc.) implementing a power conditioning device and FIG. 2 illustrates one example of a wiring diagram for the generator of FIG. 1. It should be understood that the embodiments described herein are not limited to the examples shown in FIG. 1 and FIG. 2, and are applicable to any generator configuration. The generator, in at least some embodiments, includes an engine block, a voltage regulator block, and a control panel block. Each of these blocks is electrically and/or mechanically coupled to one or more of the other blocks. The term “block” as used herein refers to a discrete functional unit, component, or system within the generator. It should be understood that the generator, in at least some embodiments, includes other blocks and components that are not shown in FIG. 1 or FIG. 2 for brevity.

The engine block represents the components that are the source of mechanical energy in the generator. The engine is powered by fuel and produces mechanical power in the form of rotational motion. This power is used to, for example, rotate an alternator's rotor or armature. The alternator is responsible for converting the mechanical energy provided by the engine into electrical energy. In at least some embodiments, the alternator includes a stator (a set of coils of wire) and a rotor (a rotating magnetic field). When the rotor is spun by the engine, the changing magnetic field induces an alternating current (AC) in the stator windings.

The voltage regulator block represents the components, such as an automatic voltage regulator, that regulate the output voltage of the generator, keeping the output voltage consistent despite changes in the load or operating conditions. The voltage regulator block operates by, for example, continuously monitoring the generator's output voltage and adjusting the excitation current supplied to the rotor or field windings. If the output voltage goes above the desired level, the voltage regulator block reduces the excitation current, which reduces the strength of the electromagnetic field and brings the voltage back down. If the output voltage drops below the desired level, the voltage regulator block increases the excitation current to bring the voltage back up. In this way, the voltage regulator block helps to ensure a steady and reliable supply of power from the generator, protecting the devices powered by the generator from potentially damaging voltage fluctuations.

The control panel block represents the components providing an interface that allows a user to operate and monitor the generator. For example, through the control panel block components, a user is able to start or stop the operation of the generator, check the fuel level, determine the run time of the generator, determine the output voltage, determine the frequency of the electrical output, determine the current being produced by the generator, and the like. The control panel block also includes, for example, outlets for connecting one or more electrical devices (e.g., air conditioning units, motors, well pumps, etc.) to the generator, warning lights, automatic transfer switch controls, and the like.

In at least some embodiments, a power conditioning device (PCD) including circuitry and electrical components is implemented as part of the control panel block. For example, FIG. 2 shows the PCD situated between the circuit breaker(s) and the outlets. However, in other embodiments, the PCD is situated at another location within the control panel block or is disposed within another block of the generator. In at least some embodiments, the PCD is hardwired into the generator. However, in other embodiments, the PCD is a modular device that is plugged or removably inserted into the generator. As such, the electrical device being connected to the generator is not required to have a built-in PCD nor is the user required to purchase a separate standalone PCD that is capable of managing inrush current, performing and power factor correction as described below, a combination thereof, or the like. In at least some embodiments, the PCD includes a switch that allows a user to enable or disable the PCD. When the PCD is disabled, one or more of the power conditioning techniques (e.g., inrush current management and power factor correction) described herein are not performed. Stated differently, the power passes through the PCD in an unconditioned stated.

One example of a PCD is a modification of conventional “active control products” from Active-Controls LLC of Pompano Beach, Florida. However, other types of PCD products are also applicable. The modification is required because conventional active control devices are typically deployed to connect to the utility power delivered, that is, the power provided by a public power utility. Public power utilities have stringent power quality requirements for the amount of variation in both voltage and frequency. In contrast, a generator, such as a whole-house standby generator, operates within a greater range of frequency, voltage and start-up times. A generator is designed to work at a set RPM range. The RPM range often varies with larger load demands, such as the startup of air conditioning units or motors for pumps.

As indicated above, when many electrical devices (e.g., air conditioning units or motors) are first started, they often draw an initial surge of current that is significantly higher than their normal operating current. This phenomenon, known as inrush current, can be many times greater than the steady-state current. Inrush currents can pose serious issues, particularly for generators. For example, for generators, an inrush current can cause substantial drops in output voltage, leading to a condition known as “brownout”. In turn, this can lead to malfunctions in sensitive equipment or even complete system failures. Additionally, the generator's internal components, such as windings and bearings, can be subjected to high thermal and mechanical stresses due to the excess current, potentially leading to premature failure of the generator. Furthermore, inrush current can also lead to significant frequency dips in generator outputs, especially in smaller generators. These frequency dips can result in synchronization problems in alternating current (AC) systems and can even lead to circuit breakers tripping, interrupting the power supply.

Therefore, the PCD, in at least some embodiments, manages inrush current by controlling and limiting the high initial surge of current that occurs during the start-up of certain electrical devices, particularly those with inductive or capacitive elements. For example, the PCD implements one or more soft start techniques and components to ramp up the power supplied to the electronic device by initially reducing the generator's output voltage when the electronic device is first switched on and then slowly ramping up this voltage over a set period. This is achieved, for example, by controlling the generator's excitation current or by varying the output of an inverter, in the case of an inverter-based generator. By gradually ramping up the voltage and, therefore, the current, the PCD helps to prevent the large, sudden inrush current that can occur when the electronic device is first connected. In at least some embodiments, power electronic devices, such as thyristors, triacs, or the like, are used to control the power supplied to the electronic device (i.e., the load) coupled to the generator. These power electronic devices can rapidly switch the power on and off. Therefore, by adjusting the proportion of time, the power is on compared to the time it is off (e.g., pulse width modulation), the average power supplied to the load is effectively controlled, and abrupt changes in current can be mitigated when the electronic device is first started. This leads to a more stable output voltage and frequency and reduces the strain on the generator and other connected electronic devices.

The soft start techniques implemented by the PCD allow for a much smaller generator to operate larger loads than without the soft start techniques. For example, a 5-ton air conditioning unit generally requires at least a 22-kilowatt (kW) generator, which is the size of a typical large built-in home backup generator. This size air conditioning unit usually runs on 15 to 20 amps but can take anywhere from 110 to 150 amps to start. However, the soft start techniques implemented by the PCD reduce the startup amps by at least 80%, thereby allowing an 8-KW generator (e.g., a medium size portable generator) to run the 5-ton air conditioning unit.

In addition to implementing soft start techniques, the PCD, in at least some embodiments, also implements power factor correction techniques to improve the power factor, thereby reducing the amount of reactive power and improving the overall efficiency of the generator. For example, in at least some embodiments, the PCD performs active power factor correction to align the phase of the current and voltage waveforms, thereby maximizing the real power delivered to the load. In at least some embodiments, the PCD continually monitors the power factor by assessing the phase difference between the current and voltage waveforms. The PCD then processes this information using its internal electronic circuitry, such as a microcontroller or digital signal processor (DSP) that calculates the amount of correction required to bring the current and voltage waveforms into phase. The PCD then uses switching power electronics, such as Insulated Gate Bipolar Transistors (IGBTs) or MOSFETs, to shape the input current waveform. For example, the PCD adjusts the duty cycle of the switches to add or subtract current as needed, making the current waveform follow the voltage waveform as closely as possible. In at least some embodiments, the PCD continuously performs these processes, adapting to changes in the load and maintaining the power factor close to 1, irrespective of variations in the load or input power conditions.

In other embodiments, the PCD performs real-time power factor correction. In these embodiments, the PCD continuously monitors the power factor of the generator. For example, the PCD measures the voltage and current waveforms and determines the phase angle between them. This phase angle represents the power factor. The PCD then calculates the amount of reactive power (either inductive or capacitive) needed to correct the power factor to near unity (1). This is based on the type of load and its power factor. For example, if the load is mostly inductive (like with many motors), the PCD determines that capacitive reactive power is needed to correct the power factor. The PCD then uses, for example, a bank of capacitors, inductors, a combination of both, or the like to supply the required reactive power to the system. The PCD is able to switch these components in or out of the circuit as needed, based on the real-time calculations. In at least some embodiments, the PCD uses power electronic components, such as IGBTs to dynamically shape the current waveform, thereby correcting the power factor. The PCD, in at least some embodiments, continuously monitors the power factor and adjusts the reactive power in real time. This allows the PCD to react to changes in the load and maintain an optimal power factor under varying conditions.

In at least some embodiment, the PCD also provides surge protection in addition to inrush current management and power factor correction. For example, the PCD includes one or more electrical components to limit the voltage supplied to an electric device by either blocking or shorting to ground any unwanted voltages above a safe threshold. The surge protection components of the PCD, in at least some embodiments, are installed in parallel with the load. In normal operation, the surge protection components do not affect the circuit. However, when a voltage surge occurs, the surge protection components become conductive and divert the surge energy away from the sensitive equipment, thereby protecting it.

Also, the PCD is configured to operate during a much broader range of voltage and frequency fluctuations than conventional devices. For example, conventional devices that perform soft start or power factor correction operations typically shut down after dropping a small percentage (e.g., 6% to 10% for voltage and 1% for frequency). However, the PCD of one or more embodiments is configured to continue operating during a much larger voltage drop (or increase), e.g., a 15% or larger voltage drop, and a much larger frequency drop (or increase) e.g., a 5% or larger frequency drop. For example, the normal output of a portable generator is 240 volts, and the current disclosure contemplates continued operation if the voltage drops to about 200 volts. Such a voltage drop would result in shutdown with conventional devices. As another non-limiting example, the normal frequency in the United States is 60 Hertz, and the current disclosure contemplates continued operation if the frequency decreases to about 55 Hertz. Such a decrease would result in shutdown with conventional devices.

It should be noted that the current disclosure contemplates continued operation in the unlikely event of a fault in the PCD. Moreover, in at least some embodiments, if the PCD does shut down, the PCD is configured to come back online in much less time than conventional devices. For example, conventional devices typically take three minutes or more to come back online when they shut down. However, the PCD, in at least some embodiments, is configured to come back online in a matter of seconds, thereby reducing delay in providing conditioned power to the electrical device.

In one embodiment, the PCD is optionally electrically coupled to a two position electrical switch. In response to the electrical switch placed in a first position, the PDC is inserted into the circuit because breakers and outlets to condition the output power. In response to, the electrical switch placed in a second position causes the PCD to be removed from the circuit.

The terminology used herein is for the purpose of describing particular embodiments only and is not intended to be limiting of the disclosure. As used herein, the singular forms “a”, “an” and “the” are intended to include the plural forms as well unless the context clearly indicates otherwise. It will be further understood that the terms “comprises” “comprising”, “includes”, and/or “including”, when used in this specification, specify the presence of stated features, integers, steps, operations, elements, and/or components but do not preclude the presence or addition of one or more other features, integers, steps, operations, elements, components, and/or groups thereof.

The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

What is claimed is:

1. A power generator comprising:
an engine configured to provide mechanical energy;
a shaft mechanically coupled to the engine to transmit the mechanical energy;
an alternator mechanically coupled to the shaft and configured to cover the mechanical energy into electrical energy;
a control panel configured to manage the operation of the engine and the alternator; and
a power conditioning device disposed between one or more circuit breakers and an outlet of the control panel.

2. The power generator of claim 1, wherein the power conditioning device comprises an inrush current management system configured to gradually ramp up power supplied to a load when the load is first connected to the power generator.

3. The power generator of claim 2, wherein the inrush current management system comprises a soft start controller configured to gradually increase voltage supplied to the load over a predefined period.

4. The power generator of claim 1, wherein the power conditioning device comprises a power factor correction system configured to monitor and adjust a power factor of an output of the power generator.

5. The power generator of claim 4, wherein the power factor correction system comprises:
a monitoring unit configured to continuously measure the power factor of the generator output; and
a reactive power management unit configured to add or subtract reactive power to the generator output based on the measured power factor.

6. The power generator of claim 1, further comprising a surge protection system configured to protect the power generator and a load connected to the power generator from voltage surges.

7. The power generator of claim 1, wherein the power conditioning device is removably inserted into the control panel.

8. The power generator of claim 1, wherein the power conditioning device is hardwired into the control panel.

9. The power generator of claim 1, wherein the power generator is a portable power generator.

10. The power generator of claim 1, wherein the power generator is a standby power generator.

11. The power generator of claim 1, wherein the outlet is coupled to an air conditioning unit.

12. The power generator of claim 5, wherein the power factor correction system further comprises a two position electrical switch, whereby
in response to the electrical switch placed in a first position, the power factor correction system is inserted into the circuit because breakers and outlets to condition the output power; and
in response to, the electrical switch placed in a second position causes the power factor correction system to be removed from the circuit.

13. The power generator of claim 5, wherein the power factor correction system is adapted to work with up to a 25% drop in 240V output voltage measured across the outlet.

14. The power generator of claim 5, wherein the power factor correction system is adapted to return online in response to a fault in under 30 seconds.
